(19) United States
(12) Patent Application Publication
(10) Pub. No.: US 2011/0005467 A1
(43) Pub. Date: Jan. 13, 2011

(54) CONVERTIBLE PET CARRIER

(75) Inventor: Tibor Siklosi, Joplin, MO (US)

Correspondence Address: HEAD, JOHNSON & KACHIGIAN, 228 W 17TH PLACE, TULSA, OK, 74119, US

(73) Assignee: BERGAN, LLC, Monkey Island, OK (US)

(21) Appl. No.: 12/498,908

(22) Filed: Jul. 7, 2009

(51) Int. Cl. A01K 1/02; A01K 1/00

(52) U.S. Cl. 119/497; 119/496

(57) ABSTRACT

A travel bag having a compartment having first and second ends is disclosed. A first support strap is affixed proximate the first end of the compartment and provides a pair of retainers on opposite sides of the primary compartment. A second support strap is affixed on a first portion thereof to the second end of the primary compartment and has a second portion thereof forming a loop joined with the first portion. The second portion loops through each of the pair of retainers such that the second portion may form, in a first configuration, handles for carrying the travel bag or be pulled through the retainers toward the front end of the travel bag and form, in a second configuration, a pull loop.

### FIELD OF THE INVENTION

This disclosure relates to pet carriers in general and, more specifically, to rolling pet carriers.

### BACKGROUND OF THE INVENTION

Traveling with pets is popular with the public despite the additional troubles entailed. Pets must generally be restrained in public places and terminals, and it may be safe or otherwise beneficial to restrain the pet when constant attention cannot be given. Leashes may be utilized but generally a leash does nothing to protect the animal and in some places more restraint than a leash may be required. Sometimes only an enclosed pet carrier will meet all the requirements for protection, safety, and comfort of the pet and those around the pet.

Pet carriers can be bulky, cumbersome, and heavy and even soft-sided carriers are heavier than a leash. The weight of the animal and any food or water in the carrier must also be considered.

What is needed is a device that addresses the above, and related, issues.

### SUMMARY OF THE INVENTION

The invention of the present disclosure, in one aspect thereof, comprises a travel bag having a compartment having first and second ends. A first support strap is affixed proximate the first end of the compartment and provides a pair of retainers on opposite sides of the primary compartment. A second support strap is affixed on a first portion thereof to the second end of the primary compartment and has a second portion thereof forming a loop joined with the first portion. The second portion loops through each of the pair of retainers such that the second portion may form, in a first configuration, handles for carrying the travel bag or be pulled through the retainers toward the front end of the travel bag and form, in a second configuration, a pull loop.

In some embodiments, the second support strap and retainers are configured such that the second support strap slides through the retainers to move between the first and second configurations. The retainers may comprise D-rings. The second support strap may have a pair of stops that interact with the retainers to limit movement of the second strap in the first configuration. The stops may comprise D-rings. The first and second support straps may comprise strips of webbing sewn to the compartment.

Some embodiments further compe a set of wheels attached to the compartment. The compartment may be provided with at least one mesh panel, and may have a zippered opening to allow insertion and removal of a pet.

### BRIEF DESCRIPTION OF THE DRAWINGS

FIG. 1 is a perspective view of a convertible pet carrier in a first, carried configuration according to aspects of the present disclosure.

FIG. 2 is a perspective view of the convertible pet carrier of FIG. 1 in a second, pulled configuration.

FIG. 3 is a close up view of a pull handle of a convertible pet carrier according to aspects of the present disclosure.

FIG. 4 is a close up view of a portion of the convertible pet carrier of FIG. 1 with the strap shown in a carry handle configuration.

### DETAILED DESCRIPTION OF THE PREFERRED EMBODIMENTS

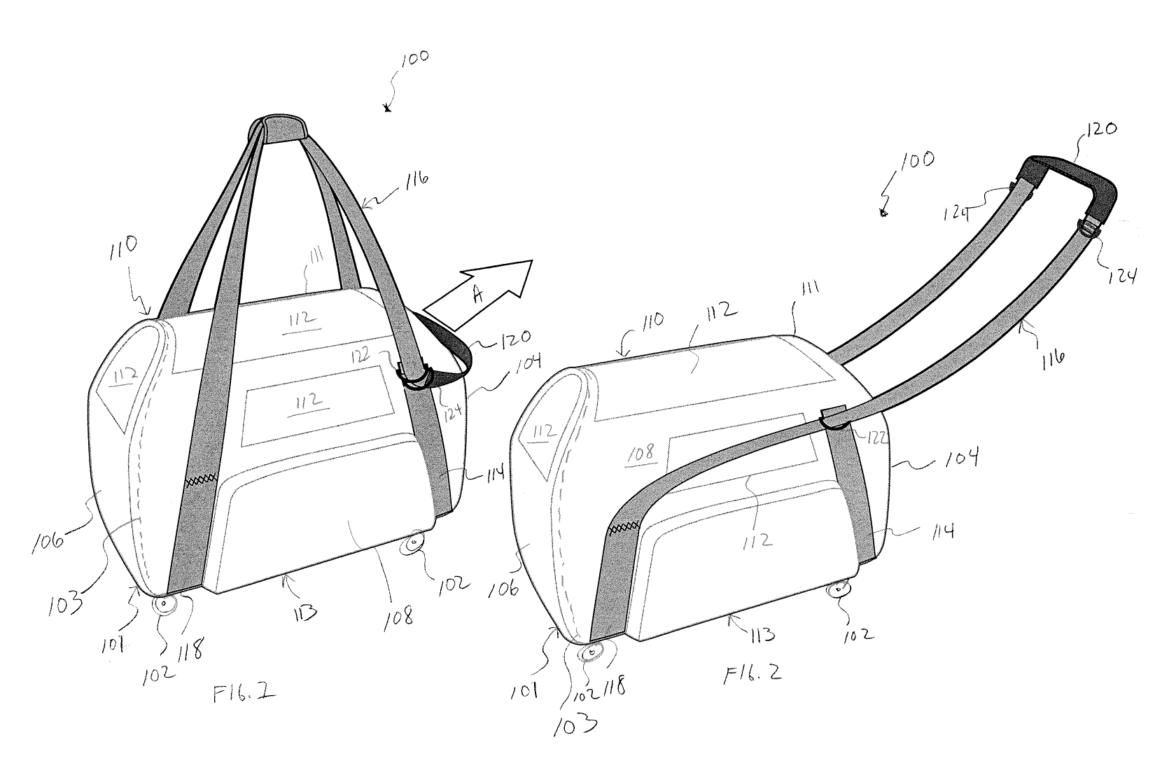

Referring now to FIG. 1, a perspective view of a convertible pet carrier in a first carried configuration according to aspects of the present disclosure is shown. The pet carrier 100 may include a primary compartment 101. The primary compartment may have wheels 102 that may be mounted on casters for ease of maneuverability. In the present embodiment the primary compartment 101 is accessed by a zippered opening 103. It is understood that in other embodiments, other openings may be provided and may be provided with different closure means. It is also understood that the pet carrier 100 may have additional compartments other than the primary compartment 101.

It can be seen that the primary compartment 101 may be defined by a first end 104 and a second end 106. The second end 106 also serves to form a part of the opening 103. In the present embodiment side 108 of the primary compartment 101 is generally continuous with the opposite side 110. Thus, in the present embodiment the sides 108, 110 continuously form the top 111 of the primary compartment 101. However, in other embodiments various other body panels may be assembled to produce the needed size and shape of the primary compartment 101. A bottom 113 of the primary compartment may be stiffened in order to support the weight of a pet or other luggage while keeping the bottom 113 away from the floor or other surface to allow the wheels 102 to operate.

It is understood that the pet carrier 100 may be utilized for other travel and transportation purposes than carrying of pets. However, in the present embodiment a series of mesh panels 112 are provided to allow for ventilation and viewing of a pet inside the primary compartment 101. It is understood that the placement and configuration of the mesh panels 112 as shown in FIG. 1 are merely exemplary as other locations and combinations are possible.

The pet carrier 100 in FIG. 1 is shown in a configuration that allows a user to carry the pet carrier 100 by a handle in a manner similar to that of a duffle bag. A first support strap 114 is affixed to the primary compartment 101 proximate the first end 104. The first support strap 114 may be a continuous piece passing from the side 108 of the primary compartment 101 to the other side 110 via the bottom 113. However, in other embodiments the first support strap 114 may comprise two pieces, one each attached to each side 108, 110.

A second support strap 116 attaches to the second end 106 of the primary compartment 101. The second support strap 116 may be continuous such that a first portion 118 of the second support strap 116 attaches to both sides 108, 110 of the primary compartment 101 crossing the bottom 113 to support the primary compartment 101 from below. However, in other embodiments the first portion 118 of the second support strap 116 may comprise discrete pieces attached only to the sides 108 110 of the primary compartment 101. The second support strap 116 may also be length adjustable in order to accommodate users or different heights or to enable the pet carrier 100 to more easily interact with or be attached to other luggage.

In some embodiments, the straps 114, 116 of the pet carrier 100, may be nylon or polyester webbing that may be spot sewn or continuously sewn to the primary compartment 101. In other embodiments the straps 114, 116 are glued or fused to the primary compartment. In some embodiments, all or portions of the straps may be semi-rigid plastics or other sufficiently pliable materials. In some embodiments, segments of the straps where flexibility is not needed (e.g., handle portions) may be made from or fitted with wooden, plastic, or metallic pieces.

A second portion 120 of the second support strap 116 is generally loose in the configuration shown in FIG. 1. A guide 122 interacts with a stop 124 to limit the withdrawal of the second portion 120 of the second support strap 116 toward the first end 104 of the primary compartment 101. In the present embodiment the guide or retainer 122 is a D-ring. In the present embodiment the stop 124 is also a D-ring. However, it is understood that any guide or retainer capable of interacting with any stop 124 to limit the travel of the second support strap 116 could be utilized. One non-limiting example is a round cord and circle ring.

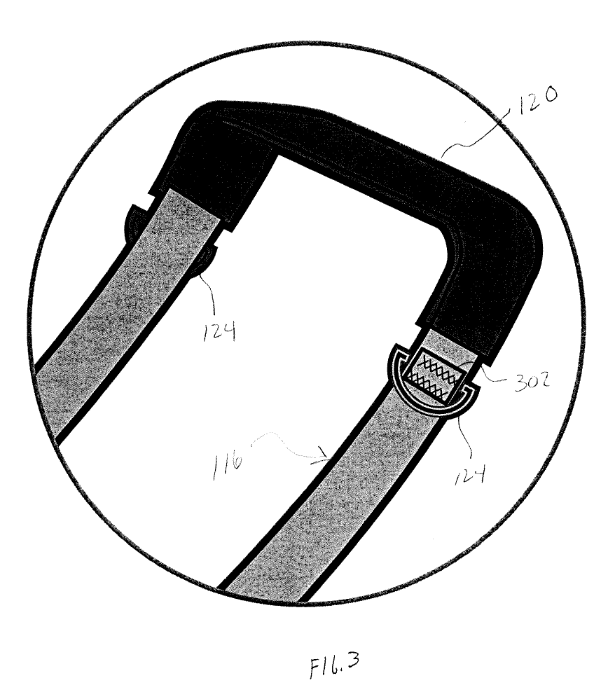

Referring now to FIG. 2 a perspective view of the convertible pet carrier FIG. 1 in a second, pulled configuration is shown. Here the second portion 120 of the second support strap 116 has been extended as shown by arrow A in FIG. 1 resulting in the pet carrier 100 converting to a pulled configuration. It can be seen that the second support strap 116 has been allowed to slide through the retainer of 122 converting the pet carrier 100. The second portion 120 may be used by one wheeling the pet carrier 100.

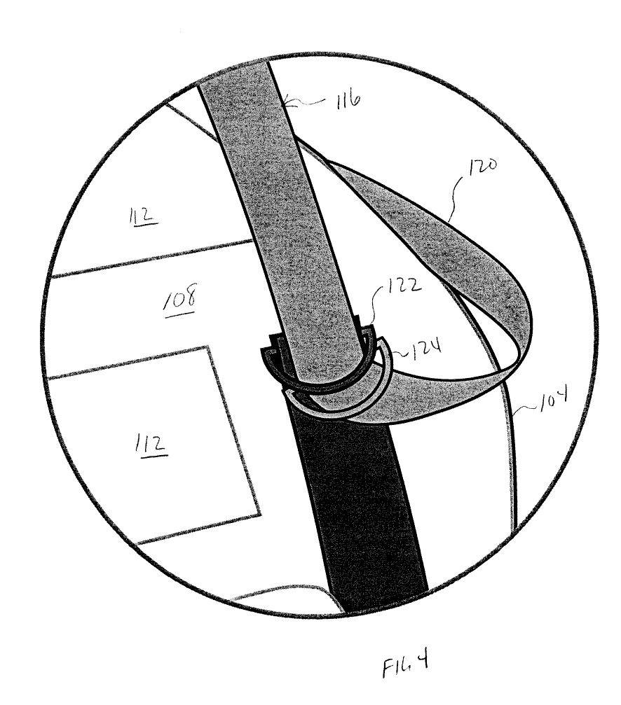

Referring now to FIG. 3 close-up view of a pull handle of a convertible pet carrier according to aspects of the present disclosure is shown. Here it can be seen how the stops or D-rings 124 are affixed to the second portion 120 of the second support strap 116. For FIGS. 2 and 3 it can also be appreciated that the pet carrier 100 in the present embodiment is symmetric from one side to the other in that similar hardware is provided on both sides (i.e., two D-rings 124). In the present embodiment the D-ring 124 is affixed to the second support strap 116 by a sewn patch 302. However other methods of attaching the stop or D-ring 124 can also be utilized. For example a brad or button could be attached to the second support strap 116 and function as the stop 124.

Referring now to FIG. 4 a close-up view of a portion of the convertible pet carrier FIG. 1 with the strap shown in a carry handle configuration is shown. In this configuration the second support strap 116 has been returned to the configuration shown in FIG. 1 and functions as a duffle bag style carry handle. Here it can be seen that the stop 124 has engaged against the guide 122 to limit the second portion 120 of the second support strap 116 from withdrawing completely through the guide 122. As described, in the present embodiment, the guide 122 and the stop 124 are both D-rings but other buttons, slide fasteners, or other implements could also be utilized.

From the foregoing it can be appreciated that the configuration of straps and other hardware on the pet carrier 100 are configured to allow the user to carry the pet carrier 100 with a duffle bag style handle and also to place the pet carrier 100 on the ground for rolling on the wheels 102 using the strap 116 as a pull handle.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A travel bag comprising:
a compartment having first and second ends;
a first support strap affixed proximate the first end of the compartment and providing a pair of retainers on opposite sides of the primary compartment; and
a second support strap affixed on a first portion thereof to the second end of the primary compartment and having a second portion thereof forming a loop joined with the first portion, the second portion looping through each of the pair of retainers such that the second portion may form, in a first configuration, handles for carrying the travel bag or be pulled through the retainers toward the front end of the travel bag and form, in a second configuration, a pull loop.

2. The travel bag of claim 1, wherein the second support strap and retainers are configured such that the second support strap slides through the retainers to move between the first and second configurations.

3. The travel bag of claim 1, wherein the retainers comprise D-rings.

4. The travel bag of claim 1, wherein the second support strap has a pair of stops that interact with the retainers to limit movement of the second strap in the first configuration.

5. The travel bag of claim 4, wherein the stops comprise D-rings.

6. The travel bag of claim 1, further comprising a set of wheels attached to the compartment.

7. The travel bag of claim 1, wherein the compartment is provided with at least one mesh panel.

8. The travel bag of claim 1, wherein the compartment has a zippered opening to allow insertion and removal of a pet.

9. The travel bag of claim 1, wherein the first and second support straps comprise strips of webbing sewn to the compartment.

10. A pet travel carrier co p sing:
a body having first and second ends, a top and bottom, and opposite sides;
a front strap attached near the first end to the bottom of the body and wrapping around the opposite sides, the front strap having strap attachments affixed thereto proximate the opposite sides; and
a continuous convertible strap attached near the second end to the bottom and opposite sides of the body and forming a loop through the strap attachments;
wherein the continuous convertible strap has a pair of spaced apart stops that engage the strap attachments when opposite sides of the convertible strap are pulled horizontally forming a carry handle;
wherein the continuous convertible strap forms a pull handle when the convertible strap is pulled between the strap attachments away from the body.

11. The travel carrier of claim 10, wherein the front strap is a segment of webbing.

12. The travel carrier of claim 10, wherein the continuous convertible strap is formed from a looped segment of webbing attached end to end.

13. The travel carrier of claim 10, wherein the strap attachments are D-rings sewn between the body and the front strap.

14. The travel carrier of claim 10, wherein the stops are D-rings sewn into the continuous strap spaced apart at least as far as the strap attachments on opposite sides of the body.

15. The travel carrier of claim 10, wherein a set of wheels is affixed to the bottom of the body.

16. The travel carrier of claim 10, wherein the body is a zippered compartment with a reinforced floor and at least one mesh panel.

17. A convertible pet carrier comprising:
a breathable enclosure having first and second ends, two sides, and a selectively openable compartment, the compartment sized to contain a pet;
a first support strap attached proximate the first end of the enclosure and providing a pair of strap guides, one on each side of the compartment; and
a second support strap having a first portion attached proximate the second end of the enclosure, to both sides of the enclosure, and having a second portion continuously interconnecting with the first portion and engaging the strap guides such that the second support strap forms carry handles in a first configuration and slides through the strap guides to form a pull handle in a second configuration.

18. The pet carrier of claim 17, further comprising a pair of spaced apart stops affixed to the second portion of the second support strap that limit the travel of the second support strap through the strap guides toward the first configuration.

19. The pet carrier of claim 18, wherein the strap guides and the stops comprise D-rings.

20. The pet carrier of claim 18, wherein the enclosure has a reinforced and wheeled floor.
